(19) United States
(12) Patent Application Publication
(10) Pub. No.: US 2009/0092756 A1
(43) Pub. Date: Apr. 9, 2009

(54) Method of Directly-Growing Three-Dimensional Nano-Net-Structures

(76) Inventors: Ningsheng Xu, Guangdong Province (CN); Jun Zhou, Guangdong Province (CN); Shaozhi Deng, Guangdong Province (CN); Li Gong, Guangdong Province (CN); Jun Chen, Guangdong Province (CN); Juncong She, Guangdong Province (CN)

Correspondence Address: MICHAEL N. LAU;LAU & ASSOCIATES, LLC, 2121 EISENHOWER AVENUE, SUITE 200, ALEXANDRIA, VA, 22314, US

(21) Appl. No.: 11/989,236

(22) PCT Filed: Aug. 1, 2005
(86) PCT No.: PCT/CN2005/001162

§ 371 Date: Jan. 23, 2008

(51) Int. Cl. B05D 3/00

(52) U.S. Cl. 427/294; 977/811

(57) ABSTRACT

The present invention provides a method for direct synthesis of three-dimensional nano-net-structures. The method is also named thermal evaporation method, which uses metal powders as the raw materials and silicon wafer, aluminum oxide plates or other high-temperature-resistant materials as substrates. The three-dimensional nano-net-structures of single crystal metal oxides are produced on a substrate by heating the metal powders to certain temperature and then keeping for a period of time under the atmosphere of inert gas. The process of the method is simple and direct, and the cost of the raw material is low. The prepared three-dimensional nano-net-structures will have great application prospects in vacuum microelectronic device and gas sensor device.

### FIELD OF THE INVENTION

The invention relates to a method of directly-growing three-dimensional nano-net-structures.

### BACKGROUND OF THE INVENTION

In recent years, nanotechnology draws wide attention worldwide and nanomaterials with different appearances have been researched and developed, such as nanoparticles, nanotubes, nanowires, nanorods, and nanobelts. However, there is no method of directly-growing three-dimensional nanostructured networks without any catalyst reported by prior art till now.

### SUMMARY OF THE INVENTION

The objective of the present invention is to offer a method of directly-growing three-dimensional nano-net-structures. The said method is used to prepare single-crystalline oxide three-dimensional nanostructured networks.

To obtain the three-dimensional nano-net-structures, the present invention comprises the following processes:
1) Clean the substrate and remove the impurities on the substrate;
2) Place metal powders (no particular requirements on the dimension of particles, 0.1 μm-0.5 mm works) and the substrate in the vacuum heater, pump them to the pressure of 5.0×10⁻² torr or lower in advance, and charge the inert gas into the vacuum heater, and keep a constant flow of gas;
3) Heat the metal powders to 1300-1450° C. (temperature of different metals might be different from each other, and metals with lower melting points require a lower temperature) and substrates to 850-1005° C. (temperature of different metals might be different from each other, and metals with lower melting points require a lower temperature); and
4) Keep the metal powders and substrate for 1-30 minutes under the desired temperature, and then cool them till their temperatures drop to the room temperature.

By the above method, single-crystalline metal oxide three-dimensional nanostructured networks will grow on the substrate by heating up metal powders and substrate in the inert gas atmosphere under high temperature.

### BRIEF DESCRIPTION OF THE DRAWINGS

FIG. 1 is SEM images of tungsten oxide three-dimensional nano-net-structures grown in tungsten boat when it is kept at 1400° C. for 1 min, 5 min, 10 min and 30 min.

FIG. 2 is SEM images of tungsten oxide three-dimensional nano-net-structures grown in tungsten boat when it is kept at 1450° C. for 10 min.

FIG. 3 shows an energy dispersive spectrum of tungsten oxide three-dimensional nano-net-structures grown in tungsten boat when it is kept at 1400° C. for 10 min.

FIG. 4 shows a TEM image and corresponding electron diffraction pattern of tungsten oxide three-dimensional nano-net-structures.

FIG. 5 shows a high-resolution TEM image and the corresponding Fourier transform image of tungsten oxide three-dimensional nano-net-structures.

FIG. 6 shows a field emission J-E curve of tungsten oxide three-dimensional nano-net-structures and the corresponding F-N plot.

### DETAILED DESCRIPTION OF THE INVENTION

A method for growing three-dimensional nano-net-structures is described herein by taking directly growing tungsten oxide three-dimensional nanostructured networks for example.

To grow tungsten oxide three-dimensional nano-net-structures, the present invention adopts the following processes:
1) Clean the substrate and remove the impurities on the substrate;
2) Put tungsten powders into the tungsten boat and heat it up in vacuum heater together with the substrate, pump them to the pressure of 5.0×10⁻² torr or lower, and charge the inert gas into the vacuum heater at a constant gas flow;
3) Heat the tungsten boat to ˜1400-1450° C. and substrates to ˜950-1005° C.;
4) Keep the tungsten boat and substrates for 1-30 minutes under the desired temperature; and
5) Cool the tungsten boat till its temperature drops to the room temperature.

In the above-mentioned processes, the silicon wafer, aluminum oxide plates and other high-temperature materials are used as the substrates. There is no requirement on geometrical shape of them.

Hereinafter a preferred embodiment of the present invention will be explained:

### EMBODIMENT

(1) Aluminum oxide plate is chosen as the substrate, and cleaned ultrasonically in acetone for 5 minutes, and then cleaned ultrasonically in ethanol absolute for 5 minutes;
(2) Tungsten powder is chosen as the tungsten source; tungsten powder in 1 g weight is put into the tungsten boat (120×20×0.3 mm). The tungsten boat is loaded into the vacuum heater (Φ350×400 mm), and the substrate is placed above the tungsten boat. The vacuum heater is pumped to ˜5×10⁻² torr. Argon gas is fed into the vacuum heater as protective gas with a flow rate of 200 standard cubic centimeters per minute. The air pressure inside the vacuum heater shall be ˜0.7 torr;
(3) Heat up the tungsten boat to the temperature of 1400° C. and 1450° C. respectively;
(4) Keep the temperature for 1 minute, 5 minutes, 10 minutes and 30 minutes respectively; and
(5) Cool the tungsten boat till its temperature drops to the room temperature.

The tungsten oxide three-dimensional nanostructured networks prepared by the above processes are analyzed with energy dispersive spectrometer (EDS), scanning electron microscopy (SEM), and transmission electron microscopy (TEM). Hereinafter, detailed description of the present invention will be given along with the drawings.

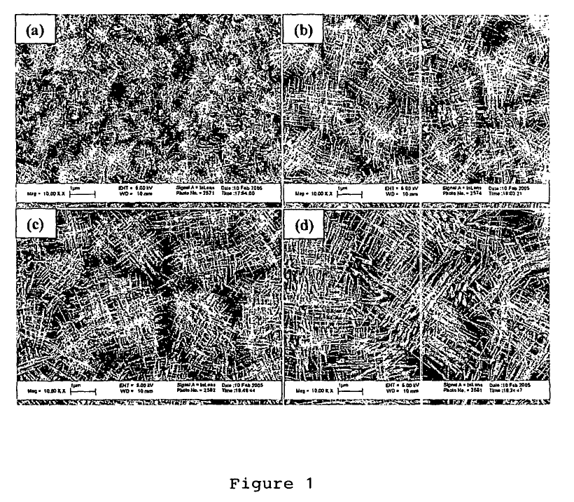

FIG. 1(a), 1(b), 1(c) and 1(d) are SEM images of tungsten oxide three-dimensional nano-net-structures grown in the tungsten boat kept at 1400° C. for 1 min, 5 min, 10 min and 30 min respectively.

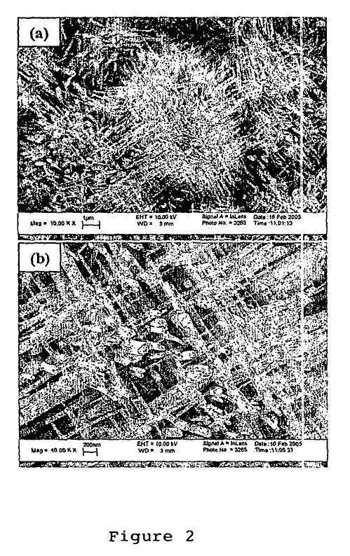

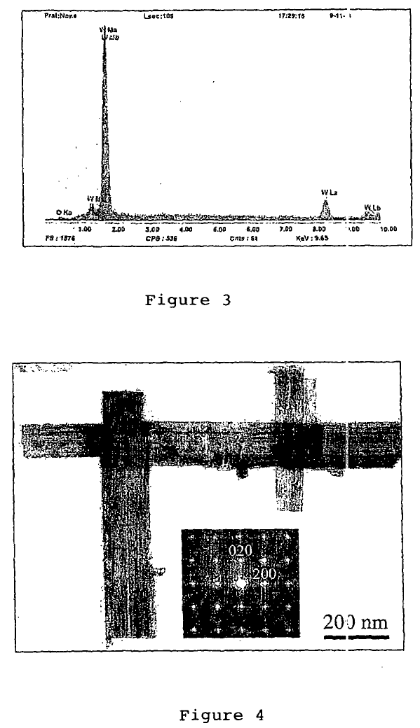

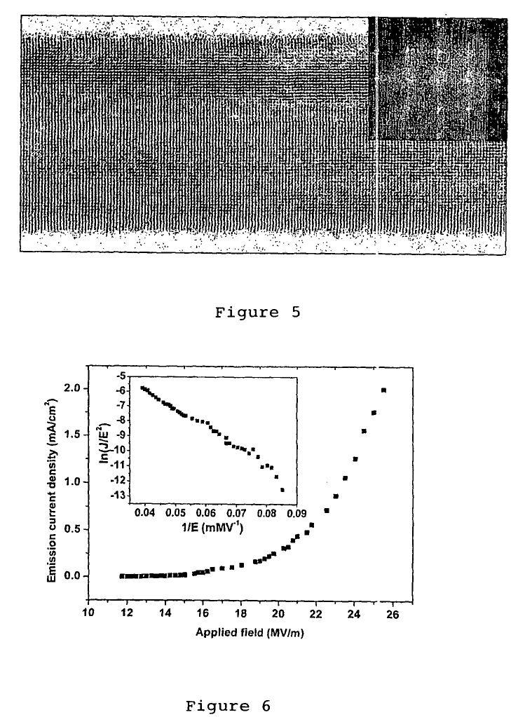

It can be found that volume of a single tungsten oxide three-dimensional nano-net-structures increases when the heating time increases. FIGS. 2(a) and 2(b) show low-definition and high-definition SEM images of tungsten oxide three-dimensional nanostructured networks grown on the aluminum oxide substrates in tungsten boat kept at 1450° C. for 10 min. It can be found that the tungsten oxide nanowires comprising the tungsten oxide three-dimensional nanostructured networks grow almost along three directions that are vertical to each other. FIG. 3 shows EDS spectrum of tungsten oxide three-dimensional nanostructured networks grown in tungsten boat kept at 1400° C. for 10 minutes. Only tungsten and oxygen elements are found in the spectrum indicating that the physical composition of three-dimensional nanostructured networks is tungsten oxide. FIG. 4 shows TEM image and the corresponding electron diffraction pattern of tungsten oxide three-dimensional nanostructured networks. It can be concluded that prepared tungsten oxide three-dimensional nanostructured network possesses a single crystal structure. FIG. 5 shows high-definition TEM image and the corresponding Fourier transform image of tungsten oxide three-dimensional nanostructured networks. As the lattice constants of different tungsten oxides are close to each very much, it can be fixed finally through simulation that the prepared tungsten oxide three-dimensional nanostructured networks have a cubic structure. FIG. 6 shows field emission J-E characteristics of tungsten oxide three-dimensional nanostructured networks and the corresponding F-N plot. F-N plot is linear and manifests that the field emission of tungsten oxide three-dimensional nanostructured networks complies with the classical field emission theory.

It can be concluded from the above analysis results that the single crystal tungsten oxide three-dimensional nanostructured networks can be grown by the simple thermal evaporation method.

Similarly, three-dimensional nano-net-structures of other metal oxides can be prepared directly. As the three-dimensional nanostructured networks maintain relatively large specific surface area, they boast great application prospects in vacuum microelectronic device and gas sensors.

1. A method of directly-growing three-dimensional nano-net-structures, comprising the following processes:
1) Clean the substrate and remove the impurities on the substrate.
2) Place metal powders and the substrate in a vacuum heater, pump metal powders, substrate and heater to the pressure of 5.0×10⁻² torr or lower in advance, and charge the inert gas into the vacuum heater at a constant gas flow;
3) Heat the metal powders to 1300-1450° C. and substrates to 850-1005° C.; and
4) Keep the metal powders and substrates 1-30 minutes under the desired temperature, and then cool them till their temperatures drop to the room temperature.

2. The method of claim 1, wherein said substrate shall be silicon, aluminum oxide or other high-temperature-resistant materials.

3. A method for growing tungsten oxide of claim 1, comprising the following processes:
(1) Clean the substrate and remove the impurities on the substrate;
(2) Put tungsten powders into the tungsten boat and heat it up in a vacuum heater together with the substrate, pump them to the pressure of 5.0×10⁻² torr or lower, and charge the inert gas into the vacuum heater at a constant gas flow;
(3) Heat the tungsten boat to ˜1400-1450° C. and substrates to ˜950-1005° C.;
(4) Keep the tungsten boat and substrates for 1-30 minutes under the desired temperature; and
(5) Cool the tungsten boat till its temperature drops to the room temperature.

4. A method for growing tungsten oxide of claim 2, comprising the following processes:
(1) Clean the substrate and remove the impurities on the substrate;
(2) Put tungsten powders into the tungsten boat and heat it up in a vacuum heater together with the substrate, pump them to the pressure of 5.0×10⁻² torr or lower, and charge the inert gas into the vacuum heater at a constant gas flow;
(3) Heat the tungsten boat to ˜1400-1450° C. and substrates to ˜950-1005° C.;
(4) Keep the tungsten boat and substrates for 1-30 minutes under the desired temperature; and
(5) Cool the tungsten boat till its temperature drops to the room temperature.

5. Applications of three-dimensional nano-net-structures grown by the method of claim 1, in vacuum microelectronic devices and gas sensors.

6. Applications of three-dimensional nano-net-structures grown by the method of claim 2, in vacuum microelectronic devices and gas sensors.

7. Applications of tungsten oxide three-dimensional nano-net-structures grown by the method of claim 3, in vacuum microelectronic devices and gas sensors.
